(19) United States
(12) Patent Application Publication
(10) Pub. No.: US 2015/0067117 A1
(43) Pub. Date: Mar. 5, 2015

(54) SYSTEM AND METHOD FOR ADVERTISEMENT OF SLA ATTRIBUTES OF A SERVICE AND THE TEST CAPABILITY OF THE ENDPOINT DEVICE

(71) Applicant: Calix, Inc., Petaluma, CA (US)

(72) Inventors: Shaun Noel Missett, Avon, CT (US); Berkay Baykal, Westborough, MA (US)

(73) Assignee: Calix, Inc., Petaluma, CA (US)

(21) Appl. No.: 14/013,963

(22) Filed: Aug. 29, 2013

(51) Int. Cl. H04L 12/24

(52) U.S. Cl. CPC H04L 41/50
USPC 709/223

(57) ABSTRACT

A system comprises a first endpoint device; and a second endpoint device coupled to the first endpoint device over a service provider network. The first endpoint device is configured to insert a Service Level Agreement (SLA) Type Length Value (TLV) element into a Protocol Data unit (PDU) to form an enhanced PDU, the first endpoint device further configured to transmit the enhanced PDU to the second endpoint device. The SLA TLV element includes fields for at least one of service configuration information and test capability information of the first endpoint device.

### BACKGROUND

During initial set-up of a service or during troubleshooting of a service failure, test equipment is typically used at one or both ends of the service to verify installation or troubleshoot the service failure. A technician at one end of a service typically communicates with another technician during the install or service troubleshooting to obtain the actual provisioning state of the equipment at the other end of the service.

### SUMMARY

In one embodiment, a system is provided. The system comprises a first endpoint device; and a second endpoint device coupled to the first endpoint device over a service provider network. The first endpoint device is configured to insert a Service Level Agreement (SLA) Type Length Value (TLV) element into a Protocol Data unit (PDU) to form an enhanced PDU, the first endpoint device further configured to transmit the enhanced PDU to the second endpoint device. The SLA TLV element includes fields for at least one of service configuration information and test capability information of the first endpoint device.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a high level block diagram of one embodiment of an exemplary system.

FIG. 2 depicts one embodiment of an exemplary SLA egress configuration TLV.

FIG. 3 depicts one embodiment of an exemplary SLA ingress configuration TLV.

FIG. 4 depicts one embodiment of an exemplary Test Capability SLA TLV.

FIG. 5 is a high level block diagram of one embodiment of an exemplary endpoint device.

FIG. 6 is a flow chart depicting one embodiment of an exemplary method of

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

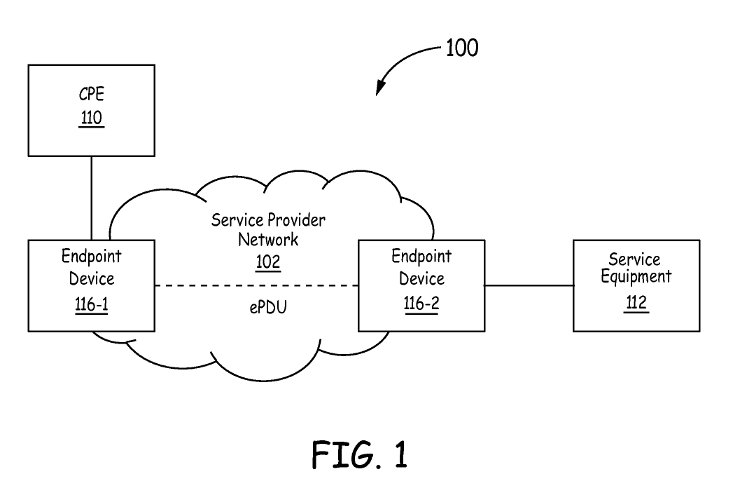

FIG. 1 is a high level block diagram of one embodiment of a system 100. System 100 includes a service provider network 102 configured to provide one or more services to customer premise equipment (CPE) 110 in customer network 106. In particular, service provider network 102 couples CPE 110 to service equipment 112 to provide the one or more services. For example, service equipment 112 can couple CPE 110 to public network 114. Hence, service equipment 112 includes any equipment configured to provide a respective service, as known to one of skill in the art. Public network 114 represents any type of network that is made available for general public access. Public network 114 commonly implements at least one layer three (L3) protocol (such as an Internet protocol or IP) to communicate data in the form of packets, where reference to layers followed by a number refers to an indicated layer of an Open Systems Interconnection (OSI) model. For this reason, public network 114 may be referred to as a packet-switched network. While shown as a single network, public network 114 may comprise one or more networks that are each interconnected to form public network 114. For example, public network 114 may comprise a large number of networks generally referred to collectively as the “Internet.”

The service provider network 102 can comprise one such network that is interconnected with other networks to form public network 114. Hence, the service provider network 102 is shown separately from public network 114 for purposes of illustrating the techniques described in this disclosure. While described with respect to service provider network 102, the techniques may be implemented with respect to any type of network, including private networks that do not generally permit the general public to access the private network without first authenticating themselves as a valid member of that network.

In addition to or in lieu of the internet service by which CPE 110 may interface with public network 114, the service provider network 102 can also be configured to provide a television service (such as a cable television service), and/or a telephone service (either by way of a plain old telephone system (POTS), which is often referred to as a “landline” service or as a Voice over IP (VoIP) service). In some instances, a service provider that owns and operates service provider network 102 may provide the infrastructure by which to provide one or more of the above noted services. Competing service providers may also contract with the service provider that owns and operates service provider network 102 to provide competing and additional services to those provided by the service provider that owns and operates service provider network 102. In any event, the service provider network 102 may provide a collection of one or more services, such as the services discussed above.

The CPE 110, which may also be referred to herein as a “subscriber device”, may include Internet-ready televisions, non-Internet-ready televisions, set-top boxes (STBs), gaming consoles, personal media players, digital video disc (DVD) players, Blu-ray players, desktop computers, laptop computers, slate or tablet computers, wireless telephones (including so-called “smart phones”), global positioning system (GPS) devices, wireless access points (WAPs), switches, hubs, printers, servers, and any other similar devices commonly employed by customers to access one or more of the services provided by service provider network 102. Customer network 106 represents a network owned and operated by customers of service provider network 102.

Typically, a customer's premises (e.g., a customer's home or business) provides the necessary infrastructure (such as the physical communication medium) to support the customer network 106. For example, customer network 106 can include coaxial cable, copper telephone lines, Ethernet cable (which is typically referred to as “category 5 cable” or “cats cable”), wireless communication medium or any other type of physical communication medium commonly employed in customer premises to facilitate the communication of data, such as voice data, Internet data, or video data. In addition, the customer network 106 can be as simple as a single subscriber device 110 coupled to the service provider network 102 or may involve multiple subscriber devices 110 networked together in a local area network (LAN), the LAN being coupled to the service provider network 102.

In this example, the service provider network 102 supports the layer two (L2) protocol referred to as Ethernet. In addition, the service provider network 102 can be implemented at the physical layer using one or more of fiber optic links, copper lines, coaxial cables, or other physical medium used for the transport of communication signals. The endpoint device 116-1 provides a subscriber drop or link 118 to the customer network 106 using one of a fiber optic link, copper line, coaxial cable, or other physical medium. Furthermore, in some embodiments, wireless communication mediums that do not involve physical communication cabling can be used for the link 118 or for communication of signals through the service provider network 102.

It is to be understood that service provider network 102 depicted in FIG. 1 has been simplified for purposes of explanation and that service provider network 102 can include multiple elements not shown, such as, but not limited to, intermediate devices between endpoint device 116-1 and 116-2, one or more access networks coupled to a core network for providing services, etc., as understood by one of skill in the art. Thus, the service provider network 102 may include combinations of various network devices such as access nodes, network switches, and routers. However, for ease of explanation only endpoint device 116-1 and 116-2 are depicted in FIG. 1. In addition, it is to be understood that endpoint devices 116-1 and 116-2 do not have to be located within a single network operator's administrative domain.

Endpoint device 116-1 couples CPE 110 to the service provider network 102. Hence, endpoint device 116-1 can also be referred to as an access node or network interface device. Similarly, endpoint device 116-2 provides an interface to couple service equipment 112 to the service provider network 102. Thus, endpoint device 116-2 can also be referred to as a network interface device.

In providing a given service to CPE 110, endpoint device 116-1 and endpoint device 116-2 communicate user data over the service provider network 102 using a networking technology, such as Ethernet. In addition, in order to provide the given service, the endpoint device 116-1 and the endpoint device 116-2, along with any intermediate equipment required for transporting the service, are first provisioned or configured for the given service and communication is established between endpoint device 116-1 and 116-2. Typically, during initial set-up of a service or during troubleshooting of a service failure, a technician at one end of the service (i.e. at endpoint device 116-1 or 116-2) verifies Key Performance Indicators (KPIs) for the given service. Such KPIs can include, but are not limited to, Throughput, Frame Loss, Delay, and Delay Variation, as defined by the Metro Ethernet Forum 10.2 standard. In addition, as known to one of skill in the art, these KPIs can be verified by using one or both of a modified RFC 2544 standard and the ITU Y.1564 standard methodologies. A measure of these KPIs can be made at multiple frame sizes and offered data rates as defined by one or more ingress and egress service parameters, such as, but not limited to, Committed Information Rate (CIR), Committed Burst Size (CBS), Excess Information Rate (EIR), and Excess Burst Size (EBS).

These measurements are typically made end-to-end for a given service either in a unidirectional manner or as a round-trip measurement. The testing can be made, in some embodiments, from a single end of a service to minimize the operational expenses of service installation. However, in conventional systems, a technician at one end of the service does not have a view into the configuration of the endpoint device at the other end (also referred to as “far end”) of the service without involving other personnel with a network wide view of the provisioning process. If the service is an out of region offering the technician may not have access to the appropriate personnel.

In system 100, however, one or both of endpoint device 116-1 and 116-2 is configured to advertise or communicate ingress and egress service parameters and/or test capabilities to the other endpoint device 116-2 and 116-1, respectively. Such advertisement/communication of service parameters and/or test capabilities can be performed automatically or in response to a trigger, such as a request from the other endpoint device.

In particular, endpoint device 116-1 and/or 116-2 is configured to insert a Service Level Agreement (SLA) Type Length Value (TLV) element into an Ethernet Operations, Administration, and Management (OAM) Protocol Data Unit (PDU) to generate an enhanced PDU (ePDU). The SLA TLV in the ePDU is used to advertise/communicate the service provisioning and the test capabilities of the respective endpoint device which generated the ePDU.

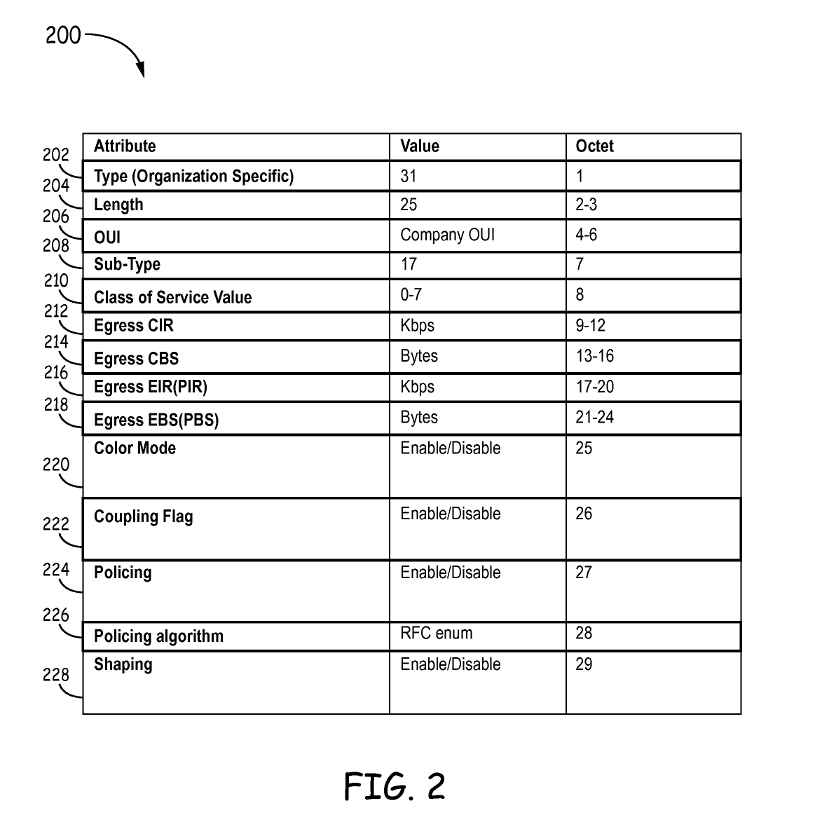

In some embodiments, the SLA TLV is inserted into a conventional Ethernet OAM PDU such as, but not limited to, the Continuity Check Protocol, Loopback Protocol, and the Link Trace Protocol known to one of skill in the art. For example, the Continuity Check Protocol is used to establish and monitor connectivity of the service endpoint device and can alarm an interruption of the connectivity. The OAM Loopback Request and Response PDUs can provide an on-demand test of connectivity and the Link Trace Protocol can be used to determine the path taken through the service provider network 102 between the endpoint device 116-1 and 116-2. Each of these PDUs can be enhanced to support a SLA TLV, such as those described in more detail below. Additionally, in some embodiments, an SLA TLV can be added to the Latching Loopback Protocol and Service Activation Testing (SAT) Protocol standards as part of the discovery process of loopback points within the network 102. Alternatively, or in addition to the PDUs mentioned above, a new OAM PDU is created in some embodiments to support the advertisement and reporting of the equipment configuration and/or test capability via an SLA TLV. FIGS. 2-4 depict exemplary SLA TLVs.

FIG. 2 depicts an exemplary SLA egress configuration TLV 200. The SLA egress configuration TLV 200 provides information regarding the egress SLA configuration of a single traffic class for the endpoint device which generated the SLA egress configuration TLV 200. As used herein, the term “egress” refers to the direction service frames are communicated on a User-Network Interface (UNI) or External Network to Network Interface (ENNI) relative to the endpoint device advertising the SLA. For example, service frames egress or exit the endpoint device at a UNI or ENNI where an ePDU containing the SLA egress configuration TLV 200 is generated.

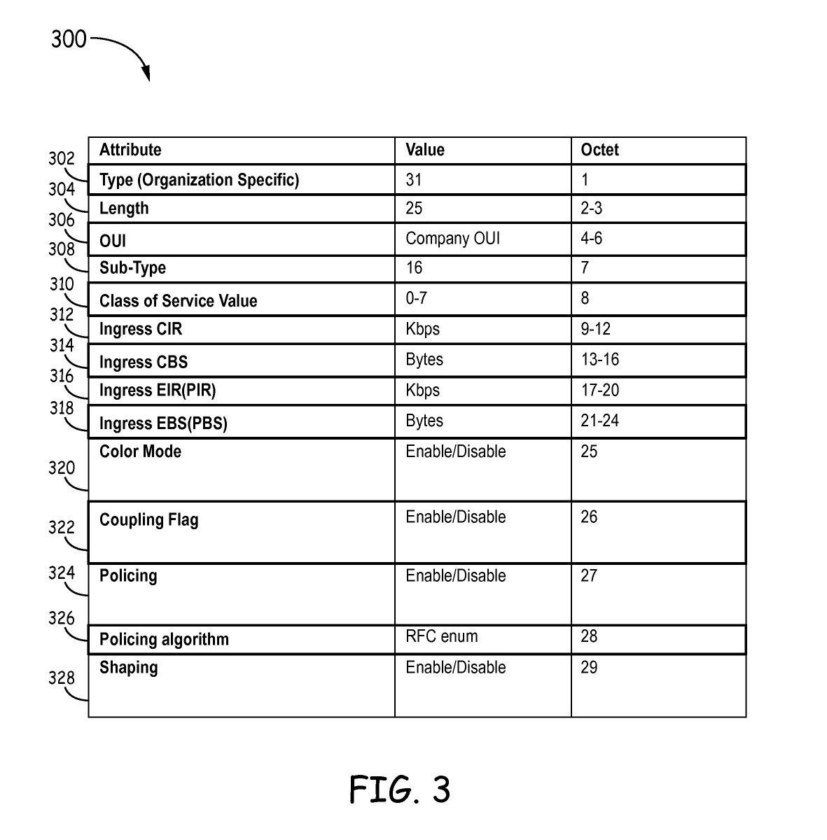

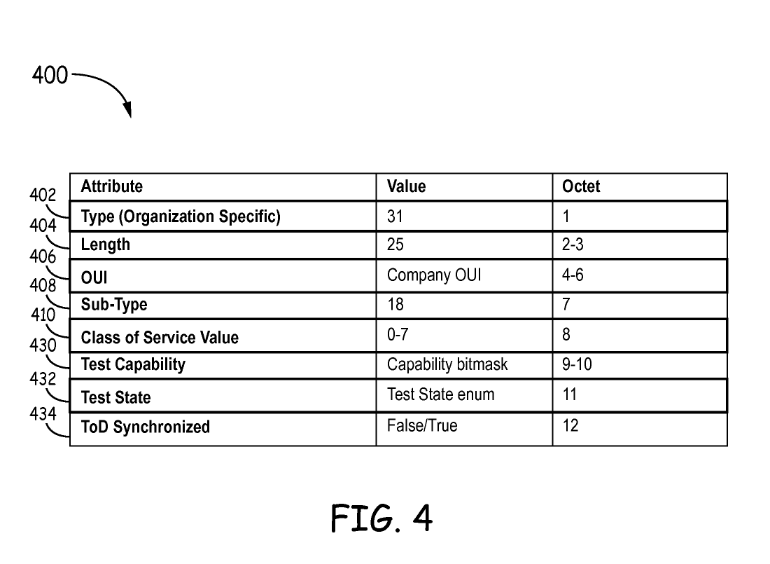

The fields of the exemplary SLA egress configuration TLV 200 begin at field or attribute 202. The field 202 indicates the type of TLV. In this example, the value of field 202 indicates to the receiving endpoint device that the TLV is an organization specific TLV. Field 204 indicates the length of the TLV 200 (e.g. the number of octets in the TLV that follow the field 204.) Field 206 contains an Organization Unique Identifier (OUI) which can be administered by a standards organization such as the Institute of Electrical and Electronics Engineers (IEEE). Field 208 is a sub-type field which identifies the type of Organization specific TLV. The value of field 208 can vary from organization to organization. In the exemplary embodiments described herein, the value of ‘17’ indicates an Egress Class of Service (CoS) SLA Configuration TLV as shown in FIG. 2. A value of ‘16’ indicates an Ingress CoS SLA Configuration TLV as shown in FIG. 3. A value of ‘18’ indicates a Test Capability SLA TLV as shown in FIG. 4.

Field 210 of TLV 200 indicates the Class of Service to which the TLV 200 corresponds. That is, field 210 specifies the Layer 2 priority bit used for frames that belong to the traffic class defined by the respective SLA TLV 200. Field 212 indicates the egress Committed Information Rate (CIR) of the given service in Kbps. Field 214 indicates the egress Committed Burst Size (CBS) of the given service in Bytes. Field 216 indicates the egress Excess Information Rate (EIR) of the given service in Kbps. In some embodiments, if an Internet Engineering Task Force (IETF) policing algorithm is implemented, field 216 does not denote the EIR, but represents a Peak Information Rate (i.e. equivalent to a single value where PIR=CIR+EIR). Field 218 indicates the Excess Burst Size (EBS) of the given service in Bytes. As with field 216, in some embodiments, if an IETF policing algorithm is implemented, field 218 does not denote the EBS, but represents a Peak Burst Size (PBS).

Field 220 indicates the configured Color Mode. When set to enable (i.e. value 1=enable), the service is Color Aware. When set to disable (i.e. value 0=disable), the service is Color Blind. Color Aware is a bandwidth profile property where a pre-determined level of bandwidth profile compliance for each service frame is taken into account when determining the level of compliance for each service frame. Color Blind is a bandwidth profile property where a pre-determined level of bandwidth profile compliance for each service frame, if present, is ignored when determining the level of compliance for each service frame. A service frame is an Ethernet frame transmitted across the UNI toward the service provider or an Ethernet frame transmitted across the UNI toward the customer premise equipment. Hence, an egress service frame is a service frame sent from the service provider network to the CPE. An ingress service frame is a service frame sent from the CPE into the Service Provider network.

Field 222 indicates if the coupling flag is enabled or disabled. A value of 1 sets the coupling flag to enable and a value of 0 sets the coupling flag to disable. When set to enable, the coupling flag allows unused tokens from the CIR traffic to be used by the Excess traffic flow. Field 224 indicates whether the service is being policed. A value of 1 indicates that the service is being policed and a value of 0 indicates that the service is not being policed. Field 226 indicates the policing algorithm applied to the service. For example, in this embodiment, a value of 0 indicates the Metro Ethernet Forum (MEF) (RFC 4115) Two Rate Three Color Marker. A value of 1 indicates the IETF (RFC 2697) Single Rate Two Color Marker. The value of 2 indicates the IETF (RFC 2698) Two Rate Three Color Marker. It is to be understood that other policing algorithms can be used in other embodiments. Field 228 indicates whether the endpoint device is configured to shape the traffic for the respective traffic class or not.

FIG. 3 depicts an exemplary SLA ingress configuration TLV 300. The SLA ingress configuration TLV 300 provides information regarding the ingress SLA configuration of a single traffic class for the endpoint device which generated the SLA ingress configuration TLV 300. As used herein, the term “ingress” refers to the direction service frames are communicated on a User-Network Interface (UNI) or External Network to Network Interface (ENNI) relative to the endpoint device advertising the SLA. For example, service frames are received by the endpoint device at a UNI or ENNI where an ePDU containing the SLA ingress configuration TLV 300 is generated. Fields 302-328 are similar to fields 202-228 in FIG. 2. However, fields 312-328 are associated with ingress service frames as opposed to egress service frames.

FIG. 4 depicts an exemplary Test Capability SLA TLV 400. The Test Capability SLA TLV 400 provides information regarding the test capabilities supported by the endpoint device which generated the ePDU containing the Test Capability SLA TLV 400. Fields 402-410 are similar to fields 202-210 described above. Field 430 is a bit mask of the SLA test modes supported by the endpoint device that generated the ePDU containing the Test Capability SLA TLV 400. For example, in this embodiment, there are 7 possible test modes. Hence, field 430 contains at least 7 bits, each bit corresponding to one of the possible test modes as shown in the exemplary Table 1 below.

TABLE 1

| BIT | TEST MODE |
|---|---|
| 0 | Loopback; Management Control |
| 1 | Loopback; Inband Latching Loopback |
| 2 | Loopback; Inband SAT Protocol |
| 3 | one-way Sink; Management Control |
| 4 | one-way Source; Management Control |
| 5 | one-way Sink; Inband SAT Protocol |
| 6 | one-way Source; Inband SAT Protocol |

It is to be understood that Table 1 is provided by way of example only and that other test modes can be represented in other embodiments. Additionally, the association of a given test mode to a particular bit in Table 1 is provided by way of example only. A value of “0” in a given bit indicates that the endpoint device does not support the associated test mode. A value of “1” in a given bit indicates that the endpoint device supports the associated test mode.

Field 432 indicates the test state of the endpoint device. In particular, a value of “0” in field 432 indicates that the endpoint device is unavailable for tests. For example, the endpoint device may be unavailable if a test is already in progress, a test resource is not available or for any other reason. A value of “1” in field 432 indicates that the endpoint device is available for testing; test resources are available; and there is no issue supporting one of the tests identified in field 430. Field 434 indicates whether the endpoint device is Time of Day (ToD) synchronized with a network timing source. If the endpoint device is ToD synchronized, then one-way delay and delay variation measurements can be made.

Hence, through the use of the SLA TLVs described above, a technician located remotely from the endpoint device generating the SLA TLVs is able to view the service SLA of interest as it is actually provisioned on the endpoint device. This enables the technician to quickly see if there is any mismatch in provisioning and avoid many hours of frustrating test and debug before isolating a problem to the far-end endpoint device as opposed to intermediate equipment. The technician is also provided information to see what testing options are available and also if a test can even be initiated. Status of the far-end endpoint device as far as testing availability is concerned can also save many hours of debug and investigation. Furthermore, it is to be understood that the fields described above are provided by way of example only and that, in other embodiments, other fields can be included in lieu of or in addition to those described above.

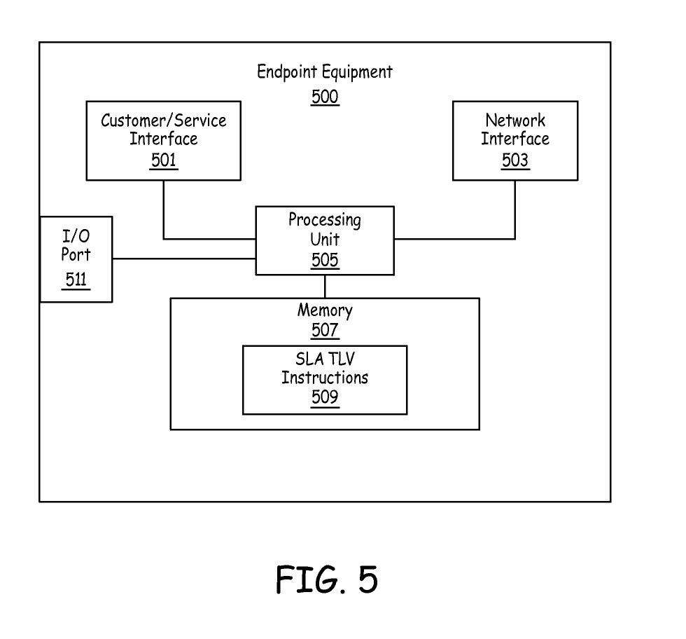

FIG. 5 is a high level block diagram of one embodiment of exemplary endpoint device 500 (also referred to as an Ethernet OAM Service Endpoint). Endpoint device 500 can be implemented as endpoint device 516-1 and/or 516-2 in FIG. 1. Endpoint device 500 includes a customer/service interface 501 which is configured to transmit data to and receive data from customer premise equipment or service provider equipment. Endpoint device 500 also includes network interface 503 which is configured to transmit data to and receive data from another endpoint device over the service provider network.

Endpoint device 500 also includes a processing unit 505. Processing unit 505 includes or functions with software programs, firmware or other computer readable instructions for carrying out various methods, process tasks, calculations, and control functions, used in the generation and communication of SLA TLVs, as described above.

These instructions are typically stored on any appropriate computer readable medium used for storage of computer readable instructions or data structures. The computer readable medium can be implemented as any available media that can be accessed by a general purpose or special purpose computer or processor, or any programmable logic device. Suitable processor-readable media may include storage or memory media such as magnetic or optical media. For example, storage or memory media may include conventional hard disks, Compact Disk-Read Only Memory (CD-ROM), volatile or non-volatile media such as Random Access Memory (RAM) (including, but not limited to, Synchronous Dynamic Random Access Memory (SDRAM), Double Data Rate (DDR) RAM, RAMBUS Dynamic RAM (RDRAM), Static RAM (SRAM), etc.), Read Only Memory (ROM), Electrically Erasable Programmable ROM (EEPROM), and flash memory, etc.

For example, in this embodiment, SLA TLV instructions 509 are stored on memory 507. SLA TLV instructions 509, when executed by processing unit 505, cause processing unit 505 to insert an SLA TLV into a PDU to generate and communicate an ePDU to another endpoint device, as described above. Endpoint device 500 also includes an Input/Output (I/O) port 511. When an SLA TLV is received over network interface 503, SLA TLV instructions 509 cause the processing unit 505 to extract data and provide data to a user/technician over I/O port 511. For example, the data can be provided to a display unit, a printer, a handheld device, etc. via I/O port 511.

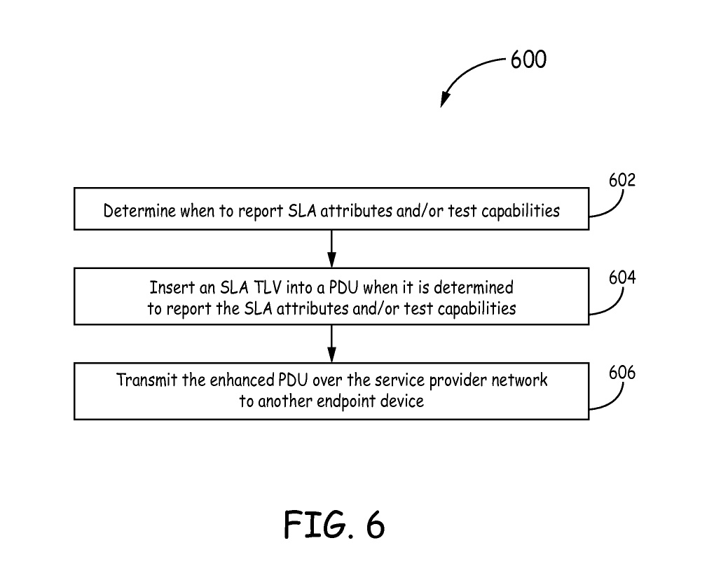

FIG. 6 is a flow chart depicting one embodiment of an exemplary method 500 of advertising SLA attributes of a service and/or the test capability of the respective endpoint device. Method 600 can be implemented in endpoint device, such as endpoint device 116-1, 116-2 or 500 described above. At block 602, it is determined when to report SLA attributes and/or test capabilities. For example, in some embodiments, the SLA attributes and/or test capabilities are reported automatically at pre-determined intervals and/or at specific times. In other embodiments, the SLA attributes and/or test capabilities are reported in response to a received request. For example, a request for reporting SLA attributes and/or test capabilities can be inserted into a PDU transmitted from another endpoint device. Upon receiving the request, the endpoint device receiving the request, begins the process of reporting the requested information.

At block 604, when it is determined to report the SLA attributes and/or test capabilities, the SLA TLV is inserted into a PDU to generate an ePDU, as discussed above. For example, one or more of an SLA egress configuration TLV, SLA ingress configuration TLV, or Test Capability SLA TLV is inserted into a PDU. In some embodiments, the PDU is an existing PDU, such as but not limited to, continuity check protocol PDU, loopback request PDU, loopback response PDU, link track protocol PDU, etc. In other embodiments, a new OAM PDU type is created to insert the SLA TLV. In other words, a new OAM PDU is a PDU configured to transport only the configuration information and/or the test capability information. Thus, an existing PDU is a PDU configured to transport data other than the configuration information or test capability information in the SLA TLV. The same PDU options can also be used by other endpoint devices to transmit a request for the SLA attributes and/or test capabilities.

At block 606, the ePDU is transmitted over the service provider network to another endpoint device where the SLA attributes and/or test capability information is extracted from the ePDU and output to a user. In this manner, a user/technician is able to verify consistent and correct provisioning. Additionally, the technician can determine the appropriate test methodology based on a received Test Capability SLA TLV. For example, if the received Test Capability SLA TLV indicates that the endpoint device supports only Service Loopback capability, the technician can determine if the service is symmetric, and if not, what the service limits on Looping back test frames will be. Additionally, in some embodiments, an automatic selection of the appropriate test methodology can be determined by the endpoint device which receives the SLA TLV based on the information in the Test Capability SLA TLV.

### EXAMPLE EMBODIMENTS

Example 1 includes a system comprising: a first endpoint device; and a second endpoint device coupled to the first endpoint device over a service provider network; wherein the first endpoint device is configured to insert a Service Level Agreement (SLA) Type Length Value (TLV) element into a Protocol Data unit (PDU) to form an enhanced PDU, the first endpoint device further configured to transmit the enhanced PDU to the second endpoint device; wherein the SLA TLV element includes fields for at least one of service configuration information and test capability information of the first endpoint device.

Example 2 includes the system of Example 1, wherein the second endpoint device is configured to extract information from the SLA TLV element and output the extracted information.

Example 3 includes the system of any of Examples 1-2, wherein the second endpoint device is configured to transmit a request for information to the first endpoint device; wherein the first endpoint device is configured to insert the SLA TLV element into the PDU in response to the request from the second endpoint device.

Example 4 includes the system of any of Examples 1-3, wherein the first endpoint device is configured to insert the SLA TLV element into the PDU to form the enhanced PDU at predetermined time intervals.

Example 5 includes the system of any of Examples 1-4, wherein the first endpoint device is configured to insert the SLA TLV into an Operations, Administration, and Management (OAM) PDU configured to transport data other than the configuration information or test capability information of the first endpoint device.

Example 6 includes the system of Example 5, wherein the OAM PDU comprises one of a continuity check protocol PDU, a loopback request PDU, a loopback response PDU, or a link track protocol PDU.

Example 7 includes the system of any of Examples 1-6, wherein the first endpoint device is configured to insert the SLA TLV into a PDU configured to transport only the configuration information or the test capability information of the first endpoint device.

Example 8 includes an endpoint device comprising: a first interface configured to receive data from and transmit data to a customer device or to a service provider device; a second interface configured to receive data from and transmit data to another endpoint device via a service provider network; and a processor coupled to the first interface and the second interface, the processor configured to direct operation of the first interface and the second interface; wherein the processor is configured to insert a Service Level Agreement (SLA) Type Length Value (TLV) element into a Protocol Data unit (PDU) to form an enhanced PDU, the processor configured to transmit the enhanced PDU to the other endpoint device via the second interface; wherein the SLA TLV element includes fields for at least one of service configuration information and test capability information of the endpoint device.

Example 9 includes the endpoint device of Example 8, wherein the processor is configured to insert the SLA TLV element into the PDU in response to a request received over the second interface from the other endpoint device.

Example 10 includes the endpoint device of any of Examples 8-9, wherein the processor is configured to insert the SLA TLV element into the PDU to form the enhanced PDU at predetermined time intervals.

Example 11 includes the endpoint device of any of Examples 8-10, wherein the processor is configured to insert the SLA TLV into an Operations, Administration, and Management (OAM) PDU configured to transport data other than the configuration information or test capability information of the endpoint device.

Example 12 includes the endpoint device of Example 11, wherein the OAM PDU comprises one of a continuity check protocol PDU, a loopback request PDU, a loopback response PDU, or a link track protocol PDU.

Example 13 includes the endpoint device of any of Examples 8-12, wherein the processor is configured to insert the SLA TLV into a PDU configured to transport only the configuration information or the test capability information of the endpoint device.

Example 14 includes a method of advertising at least one of configuration information or test capability information from a first endpoint device to a second endpoint device, the method comprising: determining when to report at least one of the configuration information or the test capability information of the first endpoint device; when it is determined to report at least one of the configuration information or the test capability information of the first endpoint device, inserting a Service Level Agreement (SLA) Type Length Value (TLV) element into a Protocol Data Unit (PDU) at the first endpoint device to form an enhanced PDU; and transmitting the enhanced PDU over a service provider network to the second endpoint device; wherein the SLA TLV includes fields for at least one of service configuration information or test capability information of the first endpoint device.

Example 15 includes the method of Example 14, wherein determining when to report at least one of the configuration information or the test capability information comprises determining when to report at least one of the configuration information or the test capability information based on pre-determined time intervals.

Example 16 includes the method of any of Examples 14-15, wherein determining when to report at least one of the configuration information or the test capability information comprises determining when to report at least one of the configuration information or the test capability information based on receipt of a request from the second endpoint device over the service provider network.

Example 17 includes the method of any of Examples 14-16, wherein inserting the SLA TLV into the PDU comprises inserting the SLA TLV into an Operations, Administration, and Management (OAM) PDU configured to transport data other than the configuration information or test capability information of the first endpoint device.

Example 18 includes the method of Example 17, wherein inserting the SLA TLV into an OAM PDU comprises inserting the SLA TLV into one of a continuity check protocol PDU, a loopback request PDU, a loopback response PDU, or a link track protocol PDU.

Example 19 includes the method of any of Examples 14-18, wherein inserting the SLA TLV into the PDU comprises inserting the SLA TLV into a PDU configured to transport only the configuration information or the test capability information of the first endpoint device.

Example 20 includes the method of any of Examples 14-19, further comprising extracting at least one of the configuration information or the test capability information from the enhanced PDU at the second endpoint device; and outputting the extracted information to a user.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. A system comprising:
a first endpoint device; and
a second endpoint device coupled to the first endpoint device over a service provider network;
wherein the first endpoint device is configured to insert a Service Level Agreement (SLA) Type Length Value (TLV) element into a Protocol Data unit (PDU) to form an enhanced PDU, the first endpoint device further configured to transmit the enhanced PDU to the second endpoint device;
wherein the SLA TLV element includes fields for at least one of service configuration information and test capability information of the first endpoint device.

2. The system of claim 1, wherein the second endpoint device is configured to extract information from the SLA TLV element and output the extracted information.

3. The system of claim 1, wherein the second endpoint device is configured to transmit a request for information to the first endpoint device;
wherein the first endpoint device is configured to insert the SLA TLV element into the PDU in response to the request from the second endpoint device.

4. The system of claim 1, wherein the first endpoint device is configured to insert the SLA TLV element into the PDU to form the enhanced PDU at predetermined time intervals.

5. The system of claim 1, wherein the first endpoint device is configured to insert the SLA TLV into an Operations, Administration, and Management (OAM) PDU configured to transport data other than the configuration information or test capability information of the first endpoint device.

6. The system of claim 5, wherein the OAM PDU comprises one of a continuity check protocol PDU, a loopback request PDU, a loopback response PDU, or a link track protocol PDU.

7. The system of claim 1, wherein the first endpoint device is configured to insert the SLA TLV into a PDU configured to transport only the configuration information or the test capability information of the first endpoint device.

8. An endpoint device comprising:
a first interface configured to receive data from and transmit data to a customer device or to a service provider device;
a second interface configured to receive data from and transmit data to another endpoint device via a service provider network; and
a processor coupled to the first interface and the second interface, the processor configured to direct operation of the first interface and the second interface;
wherein the processor is configured to insert a Service Level Agreement (SLA) Type Length Value (TLV) element into a Protocol Data unit (PDU) to form an enhanced PDU, the processor configured to transmit the enhanced PDU to the other endpoint device via the second interface;
wherein the SLA TLV element includes fields for at least one of service configuration information and test capability information of the endpoint device.

9. The endpoint device of claim 8, wherein the processor is configured to insert the SLA TLV element into the PDU in response to a request received over the second interface from the other endpoint device.

10. The endpoint device of claim 8, wherein the processor is configured to insert the SLA TLV element into the PDU to form the enhanced PDU at predetermined time intervals.

11. The endpoint device of claim 8, wherein the processor is configured to insert the SLA TLV into an Operations, Administration, and Management (OAM) PDU configured to transport data other than the configuration information or test capability information of the endpoint device.

12. The endpoint device of claim 11, wherein the OAM PDU comprises one of a continuity check protocol PDU, a loopback request PDU, a loopback response PDU, or a link track protocol PDU.

13. The endpoint device of claim 8, wherein the processor is configured to insert the SLA TLV into a PDU configured to transport only the configuration information or the test capability information of the endpoint device.

14. A method of advertising at least one of configuration information or test capability information from a first endpoint device to a second endpoint device, the method comprising:
determining when to report at least one of the configuration information or the test capability information of the first endpoint device;
when it is determined to report at least one of the configuration information or the test capability information of the first endpoint device, inserting a Service Level Agreement (SLA) Type Length Value (TLV) element into a Protocol Data Unit (PDU) at the first endpoint device to form an enhanced PDU; and
transmitting the enhanced PDU over a service provider network to the second endpoint device;
wherein the SLA TLV includes fields for at least one of service configuration information or test capability information of the first endpoint device.

15. The method of claim 14, wherein determining when to report at least one of the configuration information or the test capability information comprises determining when to report at least one of the configuration information or the test capability information based on pre-determined time intervals.

16. The method of claim 14, wherein determining when to report at least one of the configuration information or the test capability information comprises determining when to report at least one of the configuration information or the test capability information based on receipt of a request from the second endpoint device over the service provider network.

17. The method of claim 14, wherein inserting the SLA TLV into the PDU comprises inserting the SLA TLV into an Operations, Administration, and Management (OAM) PDU configured to transport data other than the configuration information or test capability information of the first endpoint device.

18. The method of claim 17, wherein inserting the SLA TLV into an OAM PDU comprises inserting the SLA TLV into one of a continuity check protocol PDU, a loopback request PDU, a loopback response PDU, or a link track protocol PDU.

19. The method of claim 14, wherein inserting the SLA TLV into the PDU comprises inserting the SLA TLV into a PDU configured to transport only the configuration information or the test capability information of the first endpoint device.

20. The method of claim 14, further comprising extracting at least one of the configuration information or the test capability information from the enhanced PDU at the second endpoint device; and
outputting the extracted information to a user.
